(19) United States
(12) Patent Application Publication
(10) Pub. No.: US 2004/0250737 A1
(43) Pub. Date: Dec. 16, 2004

(54) Workability-improving agents for cement compositions

(76) Inventors: Minoru Yaguchi, Tokyo (JP); Toshimi Matsumoto, Chigasaki (JP); Kenichi Umezawa, Tokyo (JP)

Correspondence Address: Joseph G Curatolo, Renner Kenner Greive Bobak Taylor & Weber, Suite 280, 24500 Center Ridge Road, Westlake, OH, 44145, US

(21) Appl. No.: 10/490,322

(22) PCT Filed: Sep. 12, 2002
(86) PCT No.: PCT/EP02/10390

(30) Foreign Application Priority Data
Sep. 19, 2001 (JP) 2001-285658
May 7, 2002 (JP) 2002-131147

(51) Int. Cl. C04B 7/00

(52) U.S. Cl. 106/808

(57) ABSTRACT

A workability-improving agent for improvingt the workability of cementitious compositions comprises at least one polyalkylene oxide derivative represented by the formula (I): R¹—(CO)ₐ—(O)_{b}-(AO)ₙ—X, wherein R₁ is a hydrocarbon group of from 3 to 18 carbon atoms or a residual group of a polyamine derivative; a and b are 0 or 1; AO is an alkylene oxide of from 2 to 3 carbon atoms; (AO)ₙ is a homopolymer or a block or random copolymer of alkylene oxide units of from 2 to 3 carbon atoms, n is an integer of from 1 to 30; X is H, methyl, ethyl, propyl, butyl, SO₃Y¹ is H, Na and NH₄; and/or a hydrocarbon derivative of formula (II): R²—(CO)_{c}—OH wherein R² is a aliphatic hydrocarbon group of 8 to 18 carbon atoms, and c is an integer of 0 or 1.

The present invention relates to a workability-improving agent used for improving workability when producing cementitious compositions such as concrete and mortar, and further relates to a water-reducing admixture for cement comprising said workability-improving agent.

When producing cementitious compositions such as concrete and mortar, the most economic mixture is selected from the viewpoint of design strength, fluidity, workability, durability etc. However, since natural materials are used, it is not possible to avoid a variation in parameters such as particle diameter and particle size distribution. As a result of these variations, workability also varies and when workability, decreases, there occur problems, such as an increase in the risks involved in the work process and cracking of the concrete. For example, in mixtures with a low unit cement content, there is often a strong tendency for the workability of concrete to decrease considerably, as a result of these variations.

In such a case, it is possible to adjust the particle size distribution of the aggregate to a suitable range to improve workability. However, this makes the work more complicated and time is required for the adjustment.

It is also possible to improve workability by increasing the unit cement content. However, again this is inefficient, because of the time required to adjust the mixture, and the increase in cement content increases the cost.

It has now been found that it is possible to provide a workability-improving agent that substantially or completely overcomes these problems. The invention therefore provides a workability-improving agent for cementitious compositions, comprising at least one polyalkylene oxide derivative represented by the formula (1):

R¹—(CO)ₐ—(O)_{b}-(AO)ₙ—X (1)

wherein R¹ is a hydrocarbon group of from 3 to 18 carbon atoms or a residual group of a polyamine derivative; a and b are 0 or 1; AO is an alkylene oxide of from 2 to 3 carbon atoms; (AO)ₙ is a homopolymer or a block or random copolymer of alkylene oxide units of from 2 to 3 carbon atoms, n is an integer of from 1 to 30; X is H, methyl, ethyl, propyl, butyl, SO₃Y¹ where Y¹ is H, Na and NH₄; and/or a hydrocarbon derivative of formula (2):

R²—(CO)_{c}—OH (2)

wherein R² is a aliphatic hydrocarbon group of 8 to 18 carbon atoms, and c is an integer of 0 or 1.

The present invention further relates to the abovementioned workability-improving agent wherein the residual group of a polyamine derivative is at least one of the group consisting of polyalkylene amine, polyvinylaamine, alkylamine, polyornithine, polylysine and polyarginine.

The present invention also relates to the abovementioned workability-improving agent, wherein the polyalkylene amine is at least one of the group consisting of polyethyleneimine, poly(dicarboxyalkylene)polyethyleneimine, diethyleneamine, triethylenetetramine, tetraethylenepentamine, pentaethylenehexamine, dipropylenetriamine, tripropylenetetramine, tetrapropylenepentamine and poly(dicarboxyalkylene)polyamideamine.

The present invention further relates to the abovementioned work-ability-improving agent wherein the weight ratio of the polyalkylene oxide derivative to the hydrocarbon derivative lies between 99/1 and 30/70.

The present invention also relates to the abovementioned workability-improving agent, wherein the weight proportion of ethylene oxides contained in the polyalkylene oxide derivatives is at least 12%, preferably at least 40%.

The present invention also relates to a method of improving the workability of a cementitious composition comprising water and cement, comprising the addition to the composition of a workability-improving agent as hereinabove described.

The present invention also relates to a fluid cementitious composition of improved workability, comprising cement, water and a workability-improving agent as hereinabove described.

The present invention also relates to a water-reducing admixture for cement, comprising a workability-improving agent as hereinabove described and at least one water-reducing agent selected from the group consisting of lignosulfonate-type water-reducing agents, polycarboxylate-type water-reducing agents, polyol-type water-reducing agents, naphthalenesulfonate-type water-reducing agents and melaminesulfonate-type water-reducing agents.

The present invention further relates to the abovementioned water-reducing admixture wherein the mixing ratio of the workability-improving agent to the water-reducing agent lies between 5/95 and 70/30.

The present invention further relates to a method of reducing the water content required for the attainment of fluidity in a fluid cementitious composition, by the addition to a cementitious composition comprising cement and water of a water-reducing admixture as hereinabove defined.

According to Japanese Industrial Standard JIS A 0203 the workability of concrete is defined as “the quality of fresh concrete as shown by the ease with which work is undertaken through consistency and the level of resistance to the segregation of materials necessary for concrete of a uniform quality”. In general, the grade, grain size and proportion of fine particles of the aggregate used in concrete have a big influence on workability. The present specification, based on this definition, particularly uses slumping and bleeding as indicators of workability.

While the mechanisms leading to the improvement of workability are not completely understood, it is believed that the tiny independent air bubbles produced in the concrete by an air-entraining agent function in the manner of ball bearings. Thus, it is believed that, under conditions of an identical amount of air, the working mechanism of the workability-improving agent according to the present invention increases this ball bearing effect by reducing the size of the tiny independent air bubbles entrained in the concrete.

A preferred workability-improving agent of the present invention comprises at least one polyalkylene oxide derivative (A) represented by the formula (1):

R¹—(CO)ₐ—O—(AO)ₙ—X (1)

wherein R¹ is a hydrocarbon group of 3 to 18 carbon atoms, a and b are 0 or 1; AO is alkylene oxide of 2 to 3 carbon atoms; (AO)ₙ is a homopolymer or a block or random copolymer of alkylene oxide units of from 2 to 3 carbon atoms; n is an integer of from 1 to 30; X is H, SO₃Y¹; Y¹ represents H, Na and NH₄; and/or hydrocarbon derivatives represented by the formula (2):

R²—(CO)_{c}—OH (2)

wherein R² is a an aliphatic hydrocarbon group of 8 to 18 carbon atoms, and c is an integer of 0 or 1.

The polyalkylene oxide derivatives (A) and the hydrocarbon derivatives (B) may each be used on their own as workability-improving agent, or both may be used at the same time.

When both (A) and (B) are used at the same time, a mixing ratio of (A) to (B) of between 99/1 and 30/70 is preferred, 90/10-50/50 being particularly preferred.

Further, preferred examples of specific combinations of polyalkylene oxide derivatives (A) and hydrocarbon derivatives (B) include polyoxyethylene lauryl ether (EO=6) and octanol, polyoxyethylene oleate (EO=10) and decanol, polyoxyethylene tridecyl ether (EO=10) and oleynol, polyoxyethylene octyl phenyl ether (EO=12) and hexanol, polyoxyethylene 2-ethylhexyl ether (EO=9) and tridecyl alcohol, polyoxyethylene (EO=6) polyoxypropylene (PO=2)-2-ethylhexyl ether and lauryl alcohol, polyoxyethylene oleate (EO=8) and cetyl alcohol, polyoxyethylene-2-ethylhexyl ether (EO=6) and octanol, polyoxyethylene (EO=7) oxypropylene (PO=1) tridecyl ether and decanol, polyoxyethylene (EO=6) oxypropylene (PO=1)-2-ethylhexyl ether and oleate, 2-ethylhexyloxy polyoxyethylene (EO=10) sulfonic acid and octanol, oleylpolyoxyethylene (EO=25) sulfonate sodium and octanol, 2-ethylhexyloxy polyoxyethylene (EO=8) oxypropylene (PO=1) sulfonate ammoniun and decanol, polyoxyethylene (EO=12) polyethyleneimine (n=35) adduct and decanol, polyoxyethylene (EO=10) triethylenetetramine adduct and octanol, polyoxyethylene (EO=9) polyoxypropylene (PO=2) poly(dicarboxyethylene) (n=2) polyamide (n=3) amine and octanol, polyoxyethylene (EO=2) poly(dicarboxyethylene) (n=2) polyamide (n=4) amine and octanol, polyoxyethylene (EO=25) polyornithine (n=4) and octanol, polyoxyethylene (EO=12) polyethyleneimine (n=35) adduct and decanol, polyoxyethylene (EO=10) polyethyleneimine (n=3) amine and octanol. The combinations polyoxyethylene-2-ethylhexyl ether (EO=6) and octanol, polyoxyethylene (EO=7) oxypropylene (PO=1) tridecyl ether and decanol, polyoxyethylene (EO=6) oxypropylene (PO=1)-2-ethylhexyl ether and octanol, 2-ethylhexyloxy polyoxyethylene (EO=10) sulfonic acid and octanol, oleylpolyoxyethylene (EO=25) sulfonate sodium and octanol, 2-ethylhexyloxy polyoxyethylene (EO=8) oxypropylene (PO=1) sulfonate ammonium and decanol, polyoxyethylene (EO=12) polyethyleneimine (n—35) adduct and decanol, polyoxyethylene (EO=10) polyethyleneimine (n=3) amine and octanol, polyoxyethylene (EO=2) poly(dicarboxyethylene) (n=2) polyamide (n=4) amine adduct and octanol are particularly preferred.

The polyalkylene oxide derivatives (A) have, in their molecules, a homopolymer or a copolymer of alkylene oxide units of 2 to 3 carbon atoms (i.e., ethylene oxide (represented by EO hereinafter) and/or propylene oxide (represented by PO hereinafter)). The copolymer May be a block polymer or a random polymer.

From the viewpoint of water solubility, it is preferable that the weight proportion of ethylene oxide contained in the polyalkylene oxide derivatives (A) be at least 12%, even more preferably at least 40% and most preferably at least 50%.

The water-reducing admixture for cement of the present invention additionally includes a knowvn water-reducing agent (C). Suitable water-reducing agents that can be used in the present invention are not particularly limited, but typical examples include lignosulfonate types, polycarboxylate types, particularly of the types described in JP-B-S59-1833S, JP-A-S61-31333, JP-A-H02-163108, JP-A-H05-306152, JP-A-H06-64956 and Japanese Patent No. 3235002, polyol types, naphthalenesulfonate types and melaminesulfonate types. One or more such water-reducing agents can be used in combination.

Specific examples of lignosulfonate-type water-reducing agents include POZZOLITH (trade mark) No. 8 made by NMB Co., Ltd., POZZOLITH No. 70, POZZOLITH No. 70L, SANFLO (trade mark) KS made by Sanflo Paric Co., Ltd. and YAMASO (trade mark) 90 made by Yamaso Chemical Co., Ltd.

Specific examples of polycarboxylate-type water-reducing agents include RHEOBUILD (trade mark) SP8N made by NMB Co., Ltd., PARIC (trade mark) 300S made by Sanflo Paric Co. Ltd., CHUPOL (trade mark) HP-11 made by Takemoto Oil & Fats Co., Ltd. SIKAMENT (trade mark) 1100NT made by Nihon Sika Co., Ltd. and MIGHTY (trade mark) 3000S made by Kao Corp.

Specific examples of polyol-type water-reducing agents include POZZOLITH (trade mark) No. 12R and POZZOLITH No. 70L, both made by NMB Co., Ltd.

A specific example of a naphthalenesulfonate-type water-reducing agent is RHEOBUILD SP9N made by NMB Co., Ltd.

A specific example of a melaminesulfonate-type water-reducing agent is RHEOBLUILD 4000 made by NMB Co., Ltd.

In the water-reducing admixture for cement of the present invention, it is preferable from the viewpoint of the workability-improving effect and of fluidity that the weight ratio of the workability-improving agent to the water-reducing agent (C) lie between 5/95 and 70/30, and especially preferable that it lies between 10/90 and 50/50.

According to the present invention, the amount of workability-improving agent and water-reducing agent for cement can be appropriately selected; basically it may be determined so as to obtain the desired workability-improving effect or the desired fluidity. It is preferable that the amount of polyalkylene oxide derivatives (A) represented by the above-mentioned formula (1) and hydrocarbon derivatives (B) represented by the abovementioned formula (2) calculated as solid parts of the cement weight in the cementitious composition lies between 0.01 wt % and 5 wt %, and especially preferable that it lies between 0.1 wt % and 5 wt %.

The workability-improving agents and the water-reducing admixtures according to the present invention have versatility and can be mixed with other admixtures as required. Examples of other admixtures include commonly used air-entraining agents, polysaccharide derivatives, drying shrinkage reducing agents, accelerators, retarders, foaming agents, defoaming agents, rust preventing agents, quick setting agents, thickeners, water soluble high polymeric substances, etc.

The invention will now be further described by means of the following non-limiting examples.

In Table 1 below, the chemical structure of the polyalkylene oxide derivatives (A) in the present invention are given for samples A-1 to A-7 and A-9 to A-12. Moreover, the polyalkylene oxide derivative given as sample A-8 is used for the purpose of comparison.

TABLE 1
Polyalkylene oxide derivatives

| Sample | Chemical structure |
|---|---|
| A-1 | C₈H₁₇O(EO)₆(PO)₁H |
| A-2 | C₈H₁₇O(EO)₁₀SO₃H |
| A-3 | C₁₇H₃₃COO(EO)₂₅SO₃Na |
| A-4 | C₈H₁₇O(EO)₈(PO)₁SO₃NH₄ |
| A-5 | CH₃(CH₂)₁₆COO(EO)₈(PO)₁H |
| A-6 | 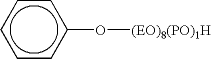 |
| A-7 | C₅H₁₁O(EO)₁(PO)₃H |
| A-8 | C₁₈H₃₇O(EO)₁₀₀H |
| A-9 | H(EI)₃₅(EO)₁₂H |
| A-10 | H₂N(EI)₃(EO)₁₀H |
| A-11 | H₂N(EI)₂OC(CH₂)₄CO(EI)₂—(PO)₂(EO)₉H |
| A-12 | C₁₃H₂₇O(EO)₇(PO)₁H |

Note:
In the table, EO represents ethylene oxide, PO represents propylene oxide and EI represents ethyleneimine.

In Table 2 below, the chemical structure of the hydrocarbon derivatives (B) in the present invention are given for samples B-1 to B-5. Moreover, the hydrocarbon derivatives given as sample B-6 is used for the purpose of comparison.

TABLE 2
Hydrocarbon derivatives

| Sample | Chemical structure |
|---|---|
| B-1 | C₈H₁₇OH |
| B-2 | C₁₀H₂₁OH |
| B-3 | C₁₂H₂₅OH |
| B-4 | C₁₈H₃₅OH |
| B-5 | CH₃(CH₂)₁₆COOH |
| B-6 | C₃H₇OH |

Concrete is prepared as shown below and the workability of the concrete is evaluated by visual observation in order to confirm the effect of the workability-improving agent of the present invention.

(Workability Evaluation)

Workability is evaluated by an experienced technician for cement compositions with equal slump and equal amount of entrained air by the manner in which slump occurred and by determining whether or not bleeding had occurred after the concrete had been left standing for 30 minutes. The evaluation is conducted in 4 grades: A (good), B (satisfactory), C (normal) and D (bad), as shown in Table 3.

TABLE 3
Workability evaluation

| | | Bleeding | | |
|---|---|---|---|---|
| Workability Evaluation | | none | little | much |
| Slump | none | A | B | C |
| | little | B | B | C |
| | much | C | C | D |

(Composition and Mixing of Concrete)

Concrete with a target slump of 18.0±1.0 cm and a target amount of entrained air of 4.5 ±0.5% is prepared with the mixtures shown in Table 4. The grade of the workability is determined by observing the workability of concrete prepared by weighing each material so as to obtain a mixed amount of 80 litres, introducing all the materials into a 100 litre pan-type forced mixer and mixing them for 120 seconds.

TABLE 4
Concrete mixtures

| | | | Unit amount (kg/m³) | | | |
|---|---|---|---|---|---|---|
| | Water/ | Fine | water | | | |
| Mix | cement | aggregate | for | | fine | coarse |
| No. | ratio (%) | ratio (%) | mixing | cement | aggregate | aggregate |
| I | 55.0 | 47.0 | 170 | 340 | 824 | 951 |
| II | 47.8 | 46.7 | 170 | 355 | 814 | 951 |
| III | 43.0 | 47.0 | 165 | 384 | 813 | 938 |
| IV | 41.3 | 46.6 | 165 | 400 | 800 | 938 |

(Materials Used)

Cement: Normal Portland cement with a density of 3.16 of Taiheiyo Cement Corporation

Fine aggregate: Oigawa river sand with a density of 2.59

Coarse aggregate: Crushed stones from Orne with a density of 2.65

Admixtures:

Polycarbonate type water-reducing agent C-1: RHEOBLUILD SP8N made by NMB Co., Ltd.

Lignosulfonate type water-reducing agent C-2: POZZOLIIJ No. 70 made by NoM Co., Ltd.

Slump measurement: according to JIS A-1101

Measurement of entrained air: according to JIS A-1128

TABLE 5
Test results

| | | | Workability-improving | | | | Water-reducing | | | | |
|---|---|---|---|---|---|---|---|---|---|---|---|
| | | | agent | | | | agent | | | | |
| | | Mix | Polyalkylene, | Hydrocarbon | Mixing | Added | | Added | Workability Evaluation | | |
| | | No. | oxide derivative | derivative | ratio | amount | Type | amount | Slump | Bleeding | Evaluation |
| Example | 1 | III | A-1 | B-1 | 70/30 | 0.2 | C-1 | 1.0 | none | none | A |
| | 2 | III | A-2 | B-1 | 70/30 | 0.2 | C-1 | 1.0 | none | none | A |
| | 3 | III | A-3 | B-1 | 70/30 | 0.2 | C-1 | 1.0 | none | none | A |
| | 4 | III | A-4 | B-1 | 70/30 | 0.2 | C-1 | 1.0 | none | none | A |
| | 5 | III | A-5 | B-1 | 70/30 | 0.2 | C-1 | 1.0 | none | none | A |
| | 6 | III | A-6 | B-1 | 70/30 | 0.2 | C-1 | 1.0 | none | none | A |
| | 7 | III | A-3 | B-2 | 70/30 | 0.2 | C-1 | 1.0 | none | none | A |
| | 8 | III | A-3 | B-3 | 70/30 | 0.2 | C-1 | 1.0 | none | none | A |
| | 9 | III | A-3 | B-4 | 70/30 | 0.2 | C-1 | 1.0 | none | none | A |
| | 10 | III | A-3 | B-5 | 70/30 | 0.2 | C-1 | 1.0 | none | none | A |
| | 11 | III | A-4 | B-2 | 85/15 | 0.2 | C-1 | 1.0 | none | none | A |
| | 12 | III | A-4 | B-2 | 35/75 | 0.2 | C-1 | 1.0 | little | none | B |
| | 13 | I | A-2 | B-4 | 70/30 | 0.2 | C-2 | 1.0 | none | little | B |
| | 14 | III | A-1 | — | 100/0 | 0.2 | C-1 | 1.0 | little | much | C |
| | 15 | III | — | B-1 | 0/100 | 0.2 | C-1 | 1.0 | little | much | C |
| | 16 | III | A-7 | B-1 | 70/30 | 0.2 | C-1 | 1.0 | little | much | C |
| | 17 | III | A-12 | B-2 | 70/30 | 0.2 | C-1 | 1.0 | none | none | A |
| Comparative | 1 | III | A-8 | B-1 | 70/30 | 0.2 | C-1 | 1.0 | much | much | D |
| Example | 2 | III | A-1 | B-6 | 70/30 | 0.2 | C-1 | 1.0 | much | much | D |
| Reference | 1 | II | — | — | — | — | C-2 | 1.0 | none | none | — |
| Example | 2 | IV | — | — | — | — | C-1 | 1.0 | none | none | — |

Note:
The added amounts given in the Table are expressed as wt % of the cement weight

TABLE 6
Test results

| | | | Workability-improving | | | | Water-reducing | | | | |
|---|---|---|---|---|---|---|---|---|---|---|---|
| | | | agent | | | | agent | | | | |
| | | Mix | Polyalkylene | Hydrocarbon | Mixing | Added | | Added | Workability Evaluation | | |
| | | No. | oxide derivative | derivative | ratio | amount | Type | amount | Slump | Bleeding | Evaluation |
| Example | 18 | III | A-9 | B-2 | 70/30 | 0.2 | C-1 | 1.0 | none | none | A |
| | 19 | III | A-10 | B-1 | 70/30 | 0.2 | C-1 | 1.0 | none | none | A |
| | 20 | III | A-11 | B-1 | 70/30 | 0.2 | C-1 | 1.0 | none | none | A |
| | 21 | III | A-9 | — | 100/0 | 0.2 | C-1 | 1.0 | none | none | A |
| | 22 | III | A-10 | B-1 | 100/0 | 0.2 | C-1 | 1.0 | none | none | A |
| | 23 | III | A-11 | B-1 | 100/0 | 0.2 | C-1 | 1.0 | none | none | A |
| | 24 | III | A-10 | B-2 | 20/50/ | 0.2 | C-1 | 1.0 | none | none | A |
| | | | A-1 | | 30 | | | | | | |

Note:
The added amounts given in the Table are expressed as wt % of the cement weight

From Tables 5 and 6 it is clear that the workability-improving effect obtained in the Examples in which, according to the present invention, a workability-improving agent is used while varying the type of polyalkylene oxide derivative (Examples 1-6, 15-16, 19-20, 22-23) and in the Examples in which a workability-improving agent is used while appropriately varying the type and mixing ratio of the polyalkylene oxide derivative and the hydrocarbon derivative (Examples 7-14, 17-18, 21, 24) is identical to the effect obtained in the Examples in which a conventional technique is used (Reference Examples 1-2). Therefore, it is possible to obtain an adequate workability-improving effect even without increasing the unit cement content.

These results show that the workability-improving effect is obtained no matter whether the polyalkylene oxide derivatives and the hydrocarbon derivatives are used on their own or in combination.

It is further confirmed that, when polyalkylene oxide derivatives and hydrocarbon derivatives are used in combination, there are also cases, depending on the combination, in which a sufficient workability-improving effect is obtained, as shown by Comparative Examples 1-2.

The water reducing properties of cement and the workability of the concrete given below are evaluated by visual observation in order to determine the effect of the water-reducing admixture according to the present invention.

(The Water-Reducing Properties of the Water-Reducing Admixture for Cement)

The water-reducing properties are judged by the added amount of water-reducing admixture, as a proportion of the cement weight, required to obtain a slump of 18.0±1.0 cm. The evaluation criteria are as follows:

A: good (the added amount is 1.0 wt % or less of the cement weight)

B: satisfactory (the added amount is between 1.0 and 1.3 wt % of the cement weight)

C: bad (the added amount is 1.3 wt % or more of the cement weight)

(Workability Evaluation)

Workability is evaluated by an experienced technician for cement compositions with equal slump and equal amount of entrained air by the manner in which slump occurs and by determining whether or not bleeding has occurred after the concrete has been left standing for 30 minutes. The criteria used for the evaluation are those given in Table 3.

(Composition and Mixing of Concrete)

Concrete with a target slump of 18.0±1.0 cm and a target amount of entrained air of 4.5±0.5% is designed with the mixtures shown in Table 7 by weighing each material so as to obtain a mixed amount of 80 litres, introducing all the materials into a 100 litre pan-type forced mixer and mixing them for 120 seconds. Workability is determined by observing the water-reducing properties of the water-reducing agent for cement and the workability of the concrete by means of the slump value of the prepared concrete.

TABLE 7
Concrete mixtures

| | | Unit amount (kg/m³) | | | |
|---|---|---|---|---|---|
| Water/ | Fine | water | | | |
| cement | aggregate | for | | fine | coarse |
| ratio (%) | ratio (%) | mixing | cement | aggregate | aggregate |
| 43.0 | 47.0 | 165 | 384 | 813 | 938 |

(Materials Used)

Cement: Normal Portland cement with a density of 3.16 of Taiheiyo Cement Corporation

Fine aggregate: Oigawa river sand with a density of 2.59

Coarse aggregate: Crushed stones from Orne with a density of 2.65

TABLE 8
Water-reducing admixture for cement
Water-reducing admixture for cement

| | Hydro- | | | |
|---|---|---|---|---|
| Polyalkylene | carbon | | | |
| oxide | deriv- | | | |
| derivatives | atives | Water-reducing agent | Mixing ratio | Sample |
| A-3 | B-1 | RHEOBUILD SP8N | 15/15/70 | AD-1 |
| A-3 | B-1 | RHEOBUILD SP8N | 5/5/90 | AD-2 |
| A-3 | B-1 | RHEOBUILD SP8N | 30/30/40 | AD-3 |
| A-2 | B-2 | POZZOLITH No. 70 | 15/15/70 | AD-4 |
| A-2 | B-2 | POZZOLITH No. 70 L | 15/15/70 | AD-5 |
| A-3 | B-1 | MIGHTY 3000 S | 15/15/70 | AD-6 |
| A-3 | B-1 | CHUPOL HP-11 | 15/15/70 | AD-7 |
| A-9 | B-2 | RHEOBUILD | 15/15/70 | AD-8 |
| A-10 | B-1 | RHEOBUILD SP8N | 15/15/70 | AD-9 |
| A-3 | B-1 | RHEOBUILD | 15/15/70 | AD-10 |
| A-9 | B-2 | RHEOBUILD 4000 | 15/15/70 | AD-11 |

Slump measurement: according to JIS A-1101

Measurement of entrained air: according to JIS A-1128

TABLE 9
Test results

| | Water-reducing | | Evaluation | | | |
|---|---|---|---|---|---|---|
| | admixture | | of the | Workability | | |
| | for cement | | water- | evaluation | | |
| | | Added | reducing | | Bleed- | |
| Example | Sample | amount | admixture | Slump | ing | Evaluation |
| 25 | AD-1 | 1.0 | A | none | none | A |
| 26 | AD-4 | 1.0 | A | none | none | A |
| 27 | AD-6 | 1.0 | A | none | none | A |
| 28 | AD-7 | 1.0 | A | none | none | A |
| 29 | AD-2 | 1.0 | A | much | none | C |
| 30 | AD-3 | 2.0 | C | little | little | B |
| 31 | AD-5 | 3.0 | C | little | little | B |
| 32 | AD-8 | 1.0 | A | none | none | A |
| 33 | AD-9 | 1.0 | A | none | none | A |
| 34 | AD-10 | 1.0 | A | none | none | A |
| 35 | AD-11 | 1.0 | A | none | none | A |

As is shown by Examples 25-35 given in Table 9, a workability-improving effect was confirmed irrespective of which sample was used. Moreover, good results for both the water-reducing properties and for workability were obtained especially in Examples 25-35.

The workability-improving effect for cement compositions resulting from the use of the workability-improving agent and the water-reducing agent for cement according to the present invention has been confirmed by the above results.

By adding the workability-improving agent and the water-reducing aadmixture for cement according to the present invention it has become possible to improve workability, which decreases considerably as a result of the variation of the aggregate used in the quality or particle diameter, particle size distribution etc., i.e. it has become possible to improve workability as desired by a simple and very economic technique unknown in the prior art.

1-10 (Canceled)

11. A workability-improving agent for improving the workability of cement compositions comprising at least one of:
polyalkylene oxide derivatives represented by the formula (1):
R¹—(CO)ₐ—(O)_{b}-(AO)ₙ—X (1)
wherein R¹ is at least one of a hydrocarbon group of from 3 to 18 carbon atoms or a residual group of a polyamine derivative;
a and b are 0 or 1;
AO is an alkylene oxide of from 2 to 3 carbon atoms;
(AO)ₙ is at least one of a homopolymer of alkylene oxide units of from 2 to 3 carbon atoms, a block of alkylene oxide units of from 2 to 3 carbon atoms, or a random copolymer of alkylene oxide units of from 2 to 3 carbon atoms;
n is an integer of from 1 to 30; and
X is at least one of H, methyl, ethyl, propyl, butyl or SO₃Y¹, where Y¹ is H, Na or NH₄; or
hydrocarbon derivatives of formula (2):
R²—(CO)_{c}—OH (2)
wherein R² is a aliphatic hydrocarbon group of 8 to 18 carbon atoms; and
c is an integer of 0 or 1.

12. The workability-improving agent of claim 11, wherein the weight ratio of the polyalkylene oxide derivatives to the hydrocarbon derivatives is about 99/1 to about 30/70.

13. The workability-improving agent of claim 11, wherein the weight proportion of ethylene oxides contained in the polyalkylene oxide derivatives is at least about 12%.

14. The workability-improving agent of claim 13 wherein the weight proportion of ethylene oxides contained in the polyalkylene oxide derivatives is at least about 40%.

15. A water-reducing admixture, comprising the workability-improving agent of claim 11 and at least one water-reducing agent selected from the group consisting of lignosulfonate water-reducing agents, polycarboxyate water-reducing agents, polyol water-reducing agents, naphthalenesulfonate water-reducing agents and melaminesulfonate water-reducing agents.

16. The water-reducing admixture of claim 15, wherein the weight ratio of the workability-improving agent to the water-reducing agent is about 5/95 to about 70/30.

17. A method of improving the workability of a fluid cementitious composition comprising water and cement, the method comprising adding the workability-improving admixture of claim 11 to the cementitious composition.

18. The method of claim 17 wherein the workability-improving admixture is added in an amount of about 0.01 weight % to about 5 weight % based on the dry weight of the cement.

19. The workability-improving agent of claim 11, wherein R¹ is a hydrocarbon group of from 3 to 18 carbon atoms, b is 1 and X is H or SO₃Y¹, where Y¹ is H, Na or NH₄.

20. The workability-improving agent of claim 19, wherein the weight ratio of the polyalkylene oxide derivatives to the hydrocarbon derivatives is about 99/1 to about 30/70.

21. The workability-improving agent of claim 19, wherein the weight proportion of ethylene oxides contained in the polyalkylene oxide derivatives is at least about 12%.

22. The workability-improving agent of claim 21 wherein the weight proportion of ethylene oxides contained in the polyalkylene oxide derivatives is at least about 40%.

23. A water-reducing admixture, comprising the workability-improving agent of claim 19 and at least one water-reducing agent selected from the group consisting of lignosulfonate water-reducing agents, polycarboxyate water-reducing agents, polyol water-reducing agents, naphthalenesulfonate water-reducing agents and melaminesulfonate water-reducing agents.

24. The water-reducing admixture of claim 23, wherein the weight ratio of the workability-improving agent to the water-reducing agent is about 5/95 to about 70/30.

25. A method of improving the workability of a fluid cementitious composition comprising water and cement, the method comprising adding the workability-improving admixture of claim 19 to the cementitious composition.

26. The method of claim 25 wherein the workability-improving admixture is added in an amount of about 0.01 weight % to about 5 weight % based on the dry weight of the cement.

27. The workability-improving agent of claim 11 wherein the residual group of a polyamine derivative is at least one selected from the group consisting of polyalkylene amine, polyvinylamine, polyallylamine, polyornithine, polylysine and polyarginine.

28. The workability-improving agent of claim 27, wherein the weight ratio of the polyalkylene oxide derivatives to the hydrocarbon derivatives is about 99/1 to about 30/70.

29. The workability-improving agent of claim 27, wherein the weight proportion of ethylene oxides contained in the polyalkylene oxide derivatives is at least about 12%.

30. The workability-improving agent of claim 29 wherein the weight proportion of ethylene oxides contained in the polyalkylene oxide derivatives is at least about 40%.

31. A water-reducing admixture, comprising the workability-improving agent of claim 27 and at least one water-reducing agent selected from the group consisting of lignosulfonate water-reducing agents, polycarboxyate water-reducing agents, polyol water-reducing agents, naphthalenesulfonate water-reducing agents and melaminesulfonate water-reducing agents.

32. The water-reducing admixture of claim 31, wherein the weight ratio of the workability-improving agent to the water-reducing agent is about 5/95 to about 70/30.

33. A method of improving the workability of a fluid cementitious composition comprising water and cement, the method comprising adding the workability-improving admixture of claim 27 to the cementitious composition.

34. The method of claim 33 wherein the workability-improving admixture is added in an amount of about 0.01 weight % to about 5 weight % based on the dry weight of the cement.

35. The workability-improving agent of claim 27, wherein the polyalkylene amine is at least one selected from the group consisting of polyethyleneimine, poly(dicarboxyalkylene)polyethyleneimine, diethyleneamine, triethylenetetramine, tetraethy lenepentamine, pentaethylenehexamine, dipropylenetriamine, tripropylenetetramine, tetrapropylenepentamine and poly(dicarboxyalkylene)polyamideamine.

36. The workability-improving agent of claim 35, wherein the weight ratio of the polyalkylene oxide derivatives to the hydrocarbon derivatives is about 99/1 to about 30/70.

37. The workability-improving agent of claim 35, wherein the weight proportion of ethylene oxides contained in the polyalkylene oxide derivatives is at least about 12%.

38. The workability-improving agent of claim 35 wherein the weight proportion of ethylene oxides contained in the polyalkylene oxide derivatives is at least about 40%.

39. A water-reducing admixture, comprising the workability-improving agent of claim 35 and at least one water-reducing agent selected from the group consisting of lignosulfonate water-reducing agents, polycarboxyate water-reducing agents, polyol water-reducing agents, naphthalenesulfonate water-reducing agents and mnelaminesulfonate water-reducing agents.

40. The water-reducing admixture of claim 39, wherein the weight ratio of the workability-improving agent to the water-reducing agent is about 5/95 to about 70/30.

41. A method of improving the workability of a fluid cementitious composition comprising water and cement, the method comprising adding the workability-improving admixture of claim 35 to the cementitious composition.

42. The method of claim 41 wherein the workability-improving admixture is added in an amount of about 0.01 weight % to about 5 weight % based on the dry weight of the cement.
